(19) United States
(12) Patent Application Publication
(10) Pub. No.: US 2004/0105137 A1
(43) Pub. Date: Jun. 3, 2004

(54) [METHOD FOR OPTIMIZING ARRANGEMENT OF LIGHT SOURCE ARRAY]

(76) Inventors: YIN-CHUN HUANG, HSINCHU (TW); CHIH-WEN HUANG, HSINCHU (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 10/605,358

(22) Filed: Sep. 25, 2003

(30) Foreign Application Priority Data
Oct. 16, 2002 (TW) 91123798

(51) Int. Cl. G02B 26/08

(52) U.S. Cl. 359/204

(57) ABSTRACT

A method for optimizing arrangement of a light source array, suitable for use in an optical scan module having an array of light sources and a sub-system assembled by other members. The optical response of the sub-system of the optical scan module is fixed. The measurements of optical response matrices of the optical scan module and the array of light sources are respectively obtained to calculate the constant value of the optical response matrix of the sub-system. The optimal value of the optical response matrix of the optical scan module is then set up to calculate the optimal value of the optical response matrix of the array of light sources. In response to the optimal value, a method of optimizing arrangement of the light source array is configured.

### CROSS REFERENCE TO RELATED APPLICATIONS

This application claims the priority benefit of Taiwan application serial no.91123798, filed on Oct. 16, 2002.

### BACKGROUND OF INVENTION

1. Field of the Invention

The invention relates in general to a method for optimizing arrangement of a light source array, and more particular, to a method for optimizing arrangement of an array of light sources applicable to an optical scan module.

2. Related Art of the Invention

In the recent years, the great advancement of computers and the development of the Internet and multi-media techniques allow for extracting an image pattern from a digital camera (DC) directly. On the other hand, the image input process of other documents or pictures requires an optical scanner to obtain an analog image therefrom. The analog image is then converted into a digital signal to be output. The users can thus perform display, recognition (OCR), edit, storage and output operation of the image file in a computer or an electronic product. According to the input method, the optical scanner can be categorized into palm scanner, sheet feed scanner, drum scanner and flatbed scanner.

Each of the palm scanner, the sheet feed scanner, the drum scanner and the flatbed scanner requires allocating a light source which radiates a light beam on the document surface. Being reflected from the document surface, the light beam is received by a sensor in the optical scan module and converted into an electronic signal to be output. The sensor includes charge-coupled device (CCD) or contact image sensor (CIS).

The following uses the flatbed scanner as an example. Referring to FIG. 1, the operation of a conventional flatbed scanner is schematically shown. A transparent document platform 30 is installed at the top of the flatbed scanner, and a reciprocally movable optical scan module 10 is installed under the transparent document platform 30. A lamp 12 and a reflector 14 can be installed at the top of the optical scan module to emit light to the document 40 disposed on the transparent document platform 30. The light reflected from the surface of the document 40 enters the optical scan module 10. Being reflected by the mirror 16 and refracted by the lens, the light is received by the sensor 20 inside of the optical scan module 10. The received light is then converted into an electronic signal to be output.

For the conventional technique, the conventional optical scan module uses a lamp as the light source. As the technique of the light emitting diode (LED) has advanced, currently the light emitting diodes able to emit red light, green light, blue light and white light have entered the mass production stage. Therefore, light emitting diodes have been designed as the light source to replace the lamp in the optical scan module. FIG. 2 shows the schematic drawing of a linear light emitting diode light source. In this prior art, many light emitting diodes are linearly arranged on a carrying board as the light source required by an optical scan module for scanning. Again, using the flatbed scanner as an example, as the optical scan module of the flatbed scanner contains a light source, a reflector, a mirror, a lens and a sensor, each of which has a different response against red, green and blue light, the response to the primary colors, red, green and blue of the digital image files scanned by the optical scan module is slightly different from the image of the actual document surface.

### SUMMARY OF INVENTION

The invention provides a method for optimizing arrangement of a light source array, primarily a light emitting diode array light source used as the light source of an optical scan module of an optical scanner. In response with the optical response of other members of the optical scan module, the arrangement distribution of the light emitting diode light source is configured to optimize the color uniformity of the scanned image of the optical scan module. The color difference from the image of the actual document source is thus reduced to enhance the fidelity of the scanned image.

In the method for optimizing arrangement of light source array provided by the present invention, optical response for the other members in the optical scan module is fixed. The optical response matrix function of the optical scan module and the light emitting diode light source array are measured to calculate the fixed value of the optical response matrix of other members. The optimal value of the optical response matrix of the light emitting diode light source array is calculated and used for configuring arrangement of the optimal light emitting diode light source array. The color uniformity of the digital image scanned by the optical scan module is thus enhanced, and the fidelity of the scanned image is then improved.

### BRIEF DESCRIPTION OF DRAWINGS

These, as well as other features of the present invention, will become more apparent upon reference to the drawings wherein.

FIG. 1 is a schematic drawing of the operation of a conventional flatbed scanner.

FIG. 2 is a schematic drawing of a conventional linear light emitting diode light source.

FIGS. 3A to 3C are schematic drawings of various arrangements of a light emitting diode light source array.

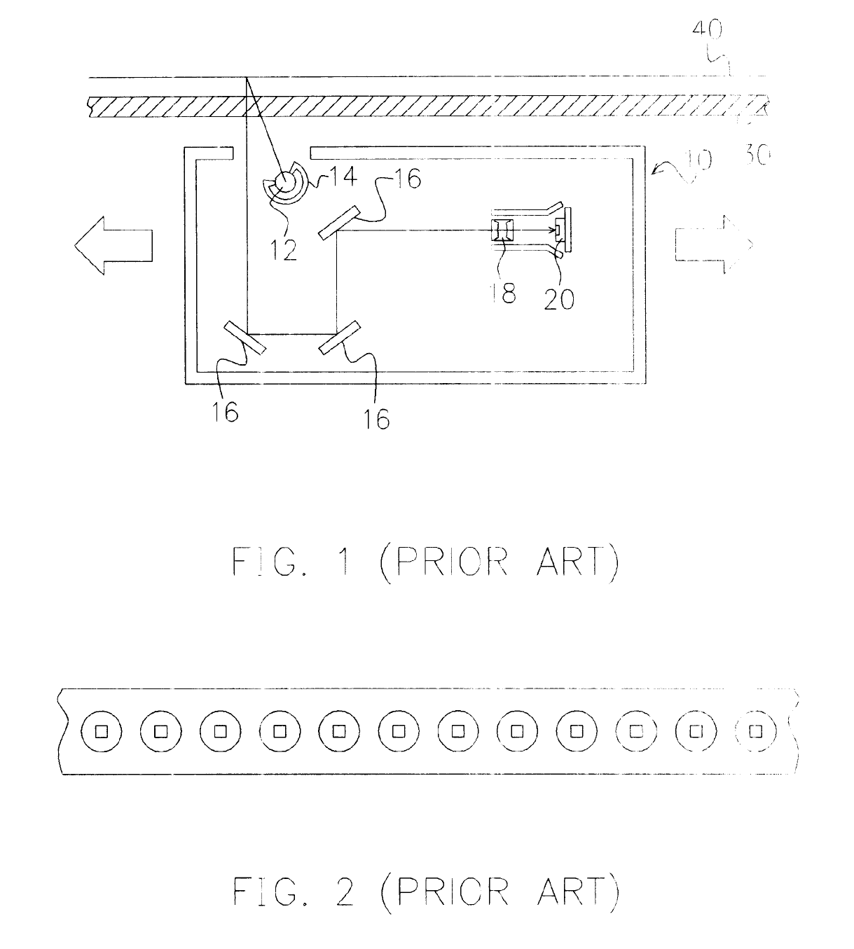

### DETAILED DESCRIPTION

In the embodiment of the present invention, a flatbed scanner is used as an example and described as follows. A transparent document platform is installed on top of the flatbed scanner. A reciprocally movable optical scan module is installed under the transparent document platform. An LED array light source and a reflector are disposed on top of the optical scan module to emit three primary color lights, that is, red, green and blue lights, on a surface of a document disposed on the transparent document platform. Being reflected by the document surface, the lights enter the optical scan module. Being reflected by a mirror and refracted by a lens, the lights are then received by a sensor.

It is appreciated that the optical response for red light, green light and blue light is different for the light emitting diode array light source, the reflector, mirror, lens and sensor of the optical scan module. Therefore, the digital image generated by the optical scan module has poor color uniformity for the three primary colors, red, green and blue. A large color deviation from the image of the actual document surface thus results. Therefore, the present invention sums up the responses for various colors from each member of the optical scan module to generate an arrangement of a set of light emitting diode array light sources. The digital image scanned by the optical scan module can thus have improved color uniformity for red, green and blue colors. The difference from the image of the actual document surface is thus reduced.

Assuming that the optical response matrix for the optical scan module, the light emitting diode light source array, the reflector, the mirror, the lens and

$$System {( \begin{matrix}R \\ G \\ B\end{matrix} )}_{respond} , Lamp {( \begin{matrix}R \\ G \\ B\end{matrix} )}_{respond} , Reflector {( \begin{matrix}R \\ G \\ B\end{matrix} )}_{respond} , Mirror {( \begin{matrix}R \\ G \\ B\end{matrix} )}_{respond} , {Lens ( \begin{matrix}R \\ G \\ B\end{matrix} )}_{respond} , and Sensor {( \begin{matrix}R \\ G \\ B\end{matrix} )}_{respond}$$

$$System {( \begin{matrix}R \\ G \\ B\end{matrix} )}_{respond} = Lamp {( \begin{matrix}R \\ G \\ B\end{matrix} )}_{respond} \times Reflector {( \begin{matrix}R \\ G \\ B\end{matrix} )}_{respond} \times Mirror {( \begin{matrix}R \\ G \\ B\end{matrix} )}_{respond} \times Lens {( \begin{matrix}R \\ G \\ B\end{matrix} )}_{respond} \times Sensor {( \begin{matrix}R \\ G \\ B\end{matrix} )}_{respond}$$

Where the optimal value of the optical response matrix is (R,G,B)=(1,1,1). To enhance the color uniformity of the optical scan module, the optical responses for the reflector, the mirror, the lens, the sensor are summed up to obtain an optimized arrangement of the light emitting diode light source array, so that the optical response of the optical scan module is (R,G,B)=(1,1,1).

As mentioned above, the optical response of the reflector, the mirror, the lens and the sensor can be fixed in advance, so that an optical response of a sub-system summed up by the optical response of each of the reflector, the

$$Sub \text{-} System {( \begin{matrix}R \\ G \\ B\end{matrix} )}_{respond} = Reflector {( \begin{matrix}R \\ G \\ B\end{matrix} )}_{respond} \times Mirror {( \begin{matrix}R \\ G \\ B\end{matrix} )}_{respond} \times Lens {( \begin{matrix}R \\ G \\ B\end{matrix} )}_{respond} \times Sensor {( \begin{matrix}R \\ G \\ B\end{matrix} )}_{respond}$$

Therefore when the optical scan module is performing a first test, the optical responses of matrices of the reflector, the mirror, the lens and the sensor are replaced by that of the sub-system to obtain the optical response

$$System {( \begin{matrix}{R}_{1} \\ {G}_{1} \\ {B}_{1}\end{matrix} )}_{respond} = Lamp {( \begin{matrix}{R}_{1} \\ {G}_{1} \\ {B}_{1}\end{matrix} )}_{respond} \times Sub \text{-} System {( \begin{matrix}{R}_{1} \\ {G}_{1} \\ {B}_{1}\end{matrix} )}_{respond}$$

The measured optical response matrices of the optical scan module and the

$${}_{System {( \begin{matrix}{R}_{1} \\ {G}_{1} \\ {B}_{1}\end{matrix} )}_{respond}}^{}{and}{}_{ Lamp {( \begin{matrix}{R}_{1} \\ {G}_{1} \\ {B}_{1}\end{matrix} )}_{respond}}^{}$$

Therefore, the optical response matrix of the sub-system is equal to the optical response matrix of the optical scan module divided by that of the light

$$Sub \text{-} System {( \begin{matrix}{R}_{1} \\ {G}_{1} \\ {B}_{1}\end{matrix} )}_{respond} = System {( \begin{matrix}{R}_{1} \\ {G}_{1} \\ {B}_{1}\end{matrix} )}_{respond} \times Lamp {( \begin{matrix}{R}_{1} \\ {G}_{1} \\ {B}_{1}\end{matrix} )}_{respond}$$

In response with the above optical response of the sub-system, an arrangement of a set of light emitting diode light sources is calculated, so that the optical response of the optical scan module is optimized. That is, the optimized value of the optical response matrix of the optical scan module is (R,G,B)=(1,1,1) as:

$$System {( \begin{matrix}R \\ G \\ B\end{matrix} )}_{respond} = System ( \begin{matrix}1 \\ 1 \\ 1\end{matrix} )$$

Therefore, the optimal value of the optical response matrix of the light

$$Lamp {( \begin{matrix}{R}_{ideal} \\ {G}_{ideal} \\ {B}_{ideal}\end{matrix} )}_{respond} = System ( \begin{matrix}1 \\ 1 \\ 1\end{matrix} ) / Sub \text{-} system {( \begin{matrix}{R}_{1} \\ {G}_{1} \\ {B}_{1}\end{matrix} )}_{respond}$$

where the fixed value of the optical response matrix of the sub-system has been previously obtained.

Therefore, the optimized value of the optical response matrix of the light emitting diode light source array derived by the above equation used to obtain the optimized arrangement of the light emitting diode light source array results in improved color uniformity of the digital image scanned by the optical scan module. The color difference from the real image of the document surface is thus reduced to enhance the fidelity of the scanned image.

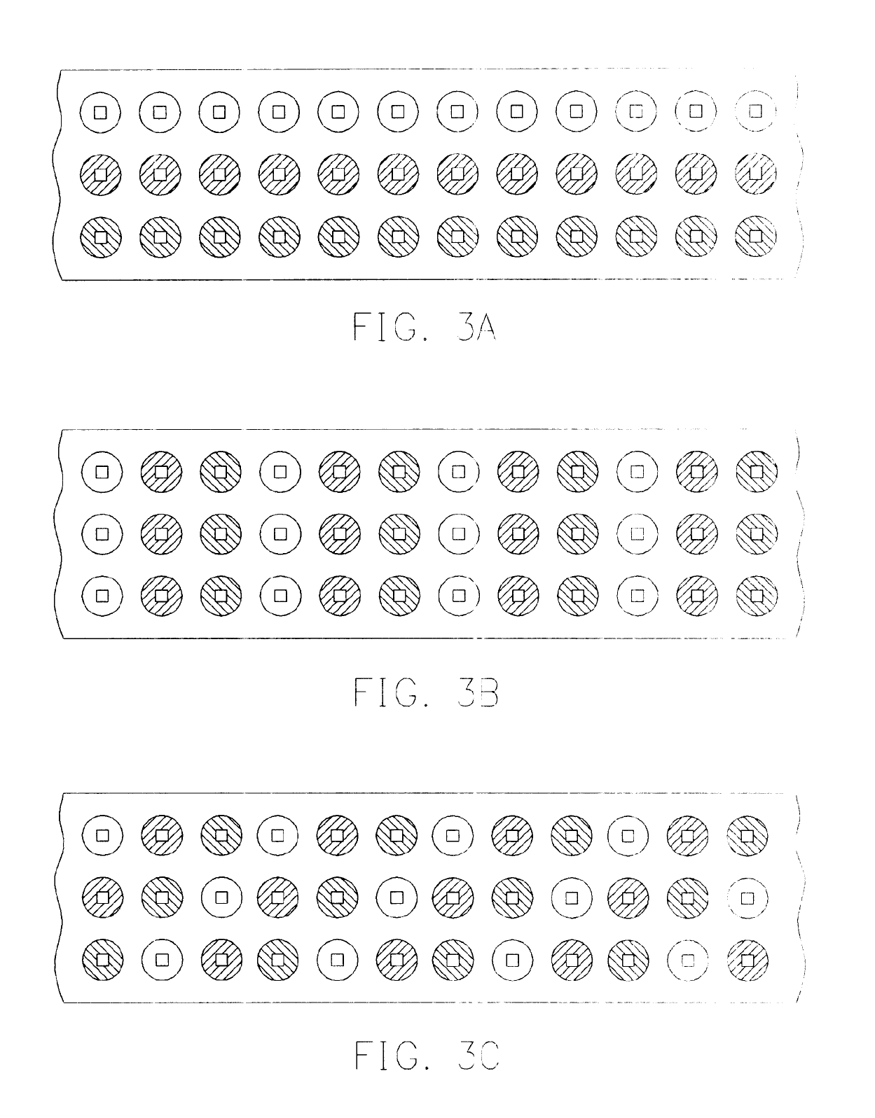

According to the color and number of light emitting diodes, various arrangements of the light emitting diode light source result. Using the arrangement for three color light emitting diodes, as shown in FIG. 3A, the light emitting diodes for each color can be vertically and linearly arranged on a carrying board. As shown in FIG. 3B, the light emitting diodes are horizontally and linearly arranged on the carrying board. In FIG. 3C, the light emitting diodes can also linearly staggered on the carrying board. Therefore, the present invention employs the above algorithm to obtain the optimized value of the optical response matrix of the light emitting diode light source array. In response to the optimized value, an optimized arrangement of the light source array is provided. In addition to the optimized arrangement for the light emitting diode light source array, the present invention may also provide the optimized arrangement for multiple point light sources to enhance the color uniformity of the digital image scanned by the optical scan module.

According to the above, the method for optimizing the arrangement of light source array of the present invention includes fixing the optical response for other members in the optical scan module first and measuring the optical response matrices of the optical scan module and the light emitting diode light source array. The fixed value of the optical response matrices for other members can thus be calculated. Further, the optimized optical response matrix of the optical scan module can be obtained to calculate the optimized optical response matrix of the light emitting diode light source array, which is then used to configure the optimized arrangement of the light emitting diode light source array. The color uniformity of the digital image scanned by the optical scan module is thus enhanced, and the fidelity of the scanned image is also improved.

Other embodiments of the invention will appear to those skilled in the art from consideration of the specification and practice of the invention disclosed herein. It is intended that the specification and examples are to be considered as exemplary only, with a true scope and spirit of the invention being indicated by the following claims.

1. A method of optimizing arrangement of a light source array, suitable for use in an optical scan module that comprises a sub-system and a light source array, wherein an optical response matrix of the optical scan module is equal to an optical response matrix of the sub-system multiplied by an optical response matrix of the light source array, the method comprising:
fixing an optical response of the sub-system to obtain measured values of the optical response matrices of the optical scan module and the light source array;
dividing the measured value of the optical response matrix of the optical scan module by the measured value of the optical response matrix of the light source array to obtain a fixed value of the optical response of the sub-system;
configuring an optimized value of the optical response matrix of the optical scan module and dividing the optimized value by an actual value of the optical response matrix of the sub-system to obtain an optimized value of the optical scan matrix of the light source array; and
responding with the optimized value of the optical response matrix of the light source array to optimize an arrangement of the light source array.

2. The method according to claim 1, wherein the light source array includes a plurality of point sources.

3. The method according to claim 2, wherein the light source array includes a plurality of light emitting diodes.

4. The method according to claim 2, wherein colors of the point light sources include red, green and blue.

5. The method according to claim 1, wherein the sub-system includes a reflector used to align light emitted from the light source array radiating in the same direction.

6. The method according to claim 1, wherein the sub-system includes a mirror to reflect light emitted from the light source array.

7. The method according to claim 1, wherein the sub-system includes a lens to refract light emitted from the light source array.

8. The method according to claim 1, wherein the sub-system includes a sensor to receive light emitted from the light source array.
